(19) United States
(12) Patent Application Publication
(10) Pub. No.: US 2006/0166370 A1
(43) Pub. Date: Jul. 27, 2006

(54) Managing semiconductor process solutions using in-process mass spectrometry

(76) Inventors: Thomas H. Bailey, San Jose, CA (US); Michael J. West, San Jose, CA (US); Larry N. Stewart, San Jose, CA (US)

Correspondence Address: Jon W. Hallman;MacPHERSON KWOK CHEN & HEID LLP, Suite 226, 1762 Technology Drive, San Jose, CA, 95110, US

(21) Appl. No.: 11/263,150

(22) Filed: Oct. 31, 2005

Related U.S. Application Data
(63) Continuation-in-part of application No. 10/094,394, filed on Mar. 8, 2002.
(63) Continuation-in-part of application No. 10/641,480, filed on Aug. 15, 2003, now Pat. No. 6,998,095.

(51) Int. Cl. G01N 24/00

(52) U.S. Cl. 436/173

(57) ABSTRACT

In one embodiment, a method of analyzing a semiconductor processing solution having at least one organic additive includes the acts of: (a) spiking a sample of the semiconductor processing solution with a first spike corresponding to the at least one organic additive and a second spike corresponding to at least one organic breakdown product of the organic additive; (b) processing the sample through a mass spectrometer to form an organic additive response, a first spike response, a breakdown response, and a second spike response; and (c) in a processor, calculating a concentration of the at least one organic additive using a ratio measurement derived from the organic additive response and the first spike response and calculating a concentration of the at least one organic breakdown product using a ratio measurement derived from the breakdown response and the second spike response.

### RELATED APPLICATION

This application claims priority to U.S. application Ser. No. 10/094,394, filed Mar. 8, 2002, and also claims priority to U.S. application Ser. No. 10/641,480, filed Aug. 15, 2003, the contents of both of which are incorporated by reference in their entirety.

### BACKGROUND OF THE INVENTION

The present invention relates to mass spectrometry, and more particularly to the management of semiconductor process solutions using in-process mass spectrometry (IPMS). The assignee of the present application, Metara, Inc., has developed an automated in-process mass spectrometry (IPMS) system that for the first time allows users such as semiconductor manufacturers to detect, identify, and quantify the chemistry of wet process baths and cleaning solutions. Unlike traditional open loop mass spectrometry techniques, the IPMS technique is automated and requires no human intervention. In contrast, the use of traditional open loop mass spectrometry requires hands-on attention from highly trained personnel.

The use of conventional mass spectrometry is typically “open loop” in that a calibration curve is first established by the users. In general, progressively concentrated (or diluted) solutions of the analyte of interest are processed through the mass spectrometer (MS) instrument and the results recorded. For example, a 10 ppm solution may be processed, then a 20 ppm solution, and so on. Having established this calibration curve, a user may then analyze the solution of interest. By comparing response from the analyte to the calibration curve, a user may determine the amount of the analyte. If, for example, the response lies halfway between the 10 ppm and 20 ppm calibration curve recordings, a quantification of 15 ppm may be assumed.

But mass spectrometers such as an inductively-coupled plasma mass spectrometer (ICPMS) are prone to response shifts over time. Moreover, there may be response shifts caused by the difference between the matrices of the calibration standard and the sample. For example, if an acidic matrix shifts in composition, the calibration process must be repeated. These response shifts may be rapid, requiring frequent re-calibrations by experienced technicians. Thus, traditional mass spectrometry analysis was inappropriate for application requiring continuous and unattended operation such as in semiconductor manufacture. In contrast to traditional techniques, however, IPMS instruments are “closed loop” and thus do not suffer from response shifts.

In an IPMS instrument, a processor controls an automatic sampling of the solution of interest, spiking the sample with a calibration standard, ionizing the spiked sample, processing the ionized spiked sample through the mass spectrometer to produce a ratio response, and analyzing the ratio response to determine the amount of one or more analytes in the sample. Unlike prior art open loop techniques, response drifts are not a problem—the drift affects the spike and sample in the same fashion and is thus cancelled in the ratio response. The addition of a known amount of spike to a sample “closes the loop” and provides accurate results. Thus, automated operation may be implemented without the necessity of manual intervention or recalibration. In addition, stable and reliable operation is assured by, in an embodiment, the use of atmospheric pressure ionization (API) such as electrospray to ionize the spiked sample. Moreover, the use of API preserves molecular species. Furthermore, the IPMS technique is applicable to the analysis of analytes in either trace or bulk concentrations.

Although the IPMS technique represents a significant advance in the art, it faces challenges as well. For example, in a semiconductor manufacturing application, a user may desire to monitor the concentrations of various constituents. In particular, plating solutions such as copper plating solutions for semiconductor applications contain a “stew” of various organic additives such as accelerators, suppressors, and levelers. The complexity of such a mixture is further exacerbated because these organic additives form breakdown products during use of the plating bath. Accordingly, there is a need in the art to provide improved IPMS systems for the monitoring of organic constituents and their breakdown components in process solutions.

### SUMMARY

This section summarizes some features of the invention. Other features are described in the subsequent sections.

In accordance with an aspect of the invention, a method of analyzing a semiconductor processing solution having at least one organic additive, is provided that includes the acts of: (a) spiking a sample of the semiconductor processing solution with a first spike corresponding to the at least one organic additive and a second spike corresponding to at least one organic breakdown product of the organic additive; (b) processing the sample through a mass spectrometer to form an organic additive response, a first spike response, a breakdown response, and a second spike response; and (c) in a processor, calculating a concentration of the at least one organic additive using a ratio measurement derived from the organic additive response and the first spike response and calculating a concentration of the at least one organic breakdown product using a ratio measurement derived from the breakdown response and the second spike response.

In accordance with another aspect of the invention, an IPMS system for managing a semiconductor processing solution is provided, comprising: a sample extraction module operable to extract samples from the semiconductor processing solution; a sample dilution and extraction module operable to spike and dilute the extracted samples to form first processed samples; a matrix elimination module operable to remove an interfering matrix from the processed samples to form second processed samples; an ionization source operable to ionize the second processed samples to form ionized samples; a mass spectrometer operable to analyze the ionized samples to form mass spectrums having spike and analyte responses; and at least one processor operable to measure concentrations of at least one organic additive and at least one corresponding organic breakdown product in the extracted samples using ratios derived from the analyte and spike responses.

In accordance with another aspect of the invention, a method of analyzing a semiconductor processing solution having at least one organic additive is provided. The method includes the acts of: (a) spiking a sample of the semiconductor processing solution with a first spike corresponding to the at least one organic additive and a second spike corresponding to at least one organic breakdown product of the organic additive; (b) processing the sample through an analytical instrument to form an organic additive response, a first spike response, a breakdown response, and a second spike response; and (c) in a processor, calculating a concentration of the at least one organic additive using a ratio measurement derived from the organic additive response and the first spike response and calculating a concentration of the at least one organic breakdown product using a ratio measurement derived from the breakdown response and the second spike response.

The invention is not limited to the features and advantages described above. Other features are described below. The invention is defined by the appended claims.

### BRIEF DESCRIPTION OF THE DRAWINGS

FIG. 1 is a block diagram of an IPMS system according to an embodiment of the invention.

FIG. 2 is a mass spectrum showing peaks corresponding to SPS, SPS(O), and an SES spike in accordance with an embodiment of the invention.

FIG. 3 illustrates the use of IPMS to manage plating bath chemistry.

### DETAILED DESCRIPTION

Reference will now be made in detail to one or more embodiments of the invention. While the invention will be described with respect to these embodiments, it should be understood that the invention is not limited to any particular embodiment. On the contrary, the invention includes alternatives, modifications, and equivalents as may come within the spirit and scope of the appended claims. Furthermore, in the following description, numerous specific details are set forth to provide a thorough understanding of the invention. The invention may be practiced without some or all of these specific details. In other instances, well-known structures and principles of operation have not been described in detail to avoid obscuring the invention.

One embodiment of the present invention will now be described in detail. This embodiment uses IPMS techniques to manage semiconductor copper electroplating baths. It will be appreciated, however, that this embodiment is merely exemplary such that the invention is not limited to the management of semiconductor electroplating baths but instead has wide application to the management of other types of process solutions. By using IPMS techniques, the concentrations of organic additives and their breakdown products in copper electroplating baths may be measured. Based upon these measurements, additional amounts of the organic additives may be added to manage the bath chemistry. Moreover, steps may be taken to manage the concentrations of the organic breakdown products.

Organic additives in semiconductor copper electroplating solutions may be broadly classified into three groups: accelerators, suppressors, and levelers. An accelerator functions by adsorbing strongly to the Cu metal surface during plating and participates in charge transfer to facilitate Cu deposition. Advantageously, the accelerator surface concentration typically increases in the bottoms of vias and trenches to promote bottom-up filling during the plating process. A commonly-used accelerator is bis (3-sulfopropyl) disulfide (SPS), which ionizes in solution as: ⁻SO₃—(CH₂)₃—S—S—(CH₂)₃—SO₃⁻. In contrast to the accelerator, the suppressor adsorbs onto the Cu surface to form a thick monolayer film that retards Cu deposition by inhibiting diffusion of Cu ions. A commonly-used suppressor comprises ethylene oxide and polypropylene copolymers (EO/PO) having a MW of approximately 2000 to 8000. The resulting polymer backbone for the suppressor may be represented as: H—(O—CH₂—CH₂)ₘ—(O—CH₂—CH—CH₃)ₙ—OH. Finally, the leveler acts to adsorb strongly on the Cu surface to inhibit plating in a similar fashion to the suppressor. One form of leveler comprises a relatively large molecular weight polyethyleneimine. Because such a leveler is charged in solution, it is more strongly adsorbed at local peaks on the Cu surface that have correspondingly higher electric fields than the remaining Cu surface. As a result, the leveler preferentially coats such local peaks such that as plating continues, the peaks are leveled because the surrounding Cu surface is preferentially plated as compared to the coated peaks.

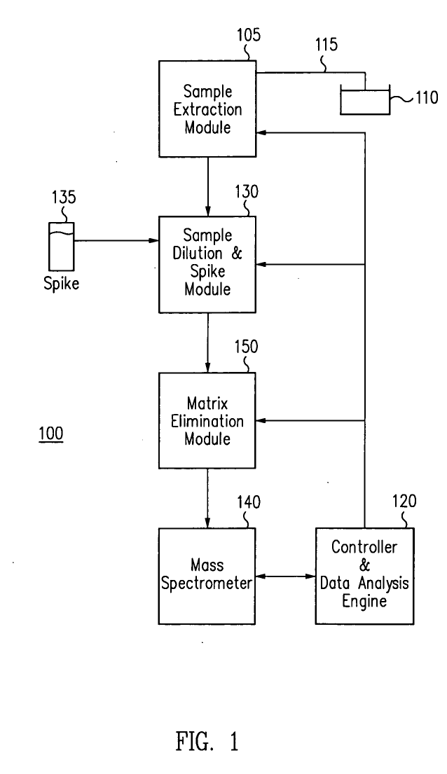

Turning now to FIG. 1, an IPMS system 100 is illustrated having a plurality of modules. A sample extraction module 105 is configured to extract sample from one or more process solution baths 110. An exemplary sample extraction module is disclosed in International Patent Application No. US05/32630, filed Sep. 14, 2005, entitled “In-Process Mass Spectrometry with Sample Multiplexing,” the contents of which are incorporated by reference herein. As discussed in this application, SEM 105 may include a reservoir (not illustrated) having a conduit 115 connected to bath 110. Vacuum is applied to the reservoir as commanded by a controller 120. The reservoir then fills with an extracted sample. By pressurizing the reservoir (as commanded by controller 120) using a compressed gas source, the extracted sample is sent to a sample dilution and spike module 130.

An exemplary sample dilution and spike module is disclosed in U.S. patent application Ser. No. 10/641,480. In one embodiment of module 130, extracted sample fills a first loop or conduit attached to a multi-way valve. Spike solution from a spike source 135 fills a second loop attached to a first multi-way valve. The multi-way valve may then be actuated such that the loops are connected with a diluent source such as a syringe pump containing a desired amount of diluent. The contents of the loops may then be mixed and diluted with the diluent. Should additional dilution be required, the diluted and spiked sample from the first multi-way valve may then be processed in additional dual-loop multi-way valves. It will be appreciated, however, that other techniques may be used to mix sample and spike solutions with appropriate diluents.

Although the matrix concentration in the resulting diluted and spiked sample from sample dilution and spike module 130 is reduced, analysis of organic additives and their breakdown products will still be hampered by the relatively high concentration of matrix that remains. For example, analysis of the concentrations of organic additives and their breakdown by-products in a Cu electroplating bath is hampered by the relatively high concentration of the matrix of sulfuric acid and copper sulfate within the bath. The resulting relatively high concentrations of protons, sulfate, and copper ions obscure the detection and quantification of constituents such as organic additives because ionization of the higher concentration ions is statistically more likely in the ionization source of a mass spectrometer 140. Thus, the matrix of copper sulfate and sulfuric acid should be removed from the diluted and spiked sample from module 130 to more accurately quantify the organic additive and breakdown product concentrations.

To perform the matrix removal, a matrix elimination module 150 processes the diluted and spiked sample from module 130. An exemplary matrix elimination module is disclosed in U.S. patent application Ser. No. 10/641,946, the contents of which are incorporated by reference herein. In one embodiment of matrix elimination module 150, a syringe pump withdraws a volume of the diluted and spiked sample from module 130. The syringe pump also withdraws a volume of a reagent such as aqueous Ba(OH)₂. The Ba(OH)₂ solution neutralizes the sulfuric acid and precipitates the Cu ions as Cu(OH)₂. However, addition of an appropriate amount of reagent such as Ba(OH)₂ depends upon the concentration of the interfering matrix. For example, in some instances it may be desirable to under-precipitate the matrix such that some matrix remains in the filtered sample. Alternatively, it may be desirable to “over-precipitate” the matrix such that some un-reacted reagent remains in the filtered sample. Attaining the desired degree of precipitation can be difficult, however, because the concentration of the matrix may change. For example, with regard to a copper plating bath, both copper sulfate and sulfuric acid can be consumed during a plating operation as well as being physically removed from the bath due to wafer removal. In addition, evaporation can occur, thereby changing copper sulfate and sulfuric acid concentrations. Moreover, replenishment of additives in the bath can also cause the matrix concentration to change if corresponding amounts of sulfuric acid and copper sulfate are not added simultaneously.

To address the need for intelligent addition of reagent to provide the desired degree of under-precipitation or over-precipitation, matrix elimination module 150 may be implemented as discussed within U.S. patent application Ser. No. ______, filed Oct. 18, 2005, entitled “Closed Loop Automated Matrix Removal, the contents of which are incorporated by reference herein. In a closed loop matrix elimination module, the addition of reagent is controlled by periodic measurements of the matrix concentration. Based upon the most-recently determined matrix concentration, the amount of reagent appropriate to provide the desired degree of precipitation is added within module 150. It will be appreciated, however, that other techniques such as ion exchange columns may be used to implement module 150.

Regardless of how module 150 is implemented to remove the matrix, a resulting processed diluted and spiked sample is then provided by module 150 to mass spectrometer 140. Mass spectrometer 140 may comprise a time of flight (TOF) electrospray mass spectrometer. However, it will be appreciated that other types of mass spectrometers may be implemented in the present invention such as inductively-coupled-plasma mass spectrometers. Moreover, the management of semiconductor process solutions may be performed using other “closed loop” analytical techniques. With regard to IPMS system 100, the analysis it performs may be considered closed loop because each extracted sample that is analyzed is analyzed with regard to an added spike solution having a known volume and concentration. Such an analysis may be contrasted with an “open loop” measurement in which an extracted sample is analyzed with regard to a previously-determined calibration standard. It will thus be appreciated that the closed loop automation practiced by IPMS system 100 is widely applicable to other analytical instruments besides mass spectroscopy. For example, a chromatography system such as high performance liquid chromatography (HPLC) could be used in place of mass spectrometer 140.

Because atmospheric pressure ionization (API) mass spectrometry preserves relatively large molecular weight species such as organic additives, the remaining discussion will assume that mass spectrometer 140 is an API mass spectrometer such as, for example, an electrospray mass spectrometer. The types of organic additives (and their breakdown products) being analyzed will typically be different depending upon whether mass spectrometer 140 is analyzing the masses of positively or negatively charged ions. In general, the analysis of positively charged ions will be denoted by the positive mode “(+)” designation whereas the analysis of negatively charged ions will be denoted by the negative mode “(−)” designation. As discussed analogously in International Patent Application No. US05/32630, IPMS system 100 may include multiple instantiations of modules 130 and 150 such that a given module is specialized for either a (+) mode or (−) mode analyses. Similarly, mass spectrometer 140 may include a plurality of probes such as disclosed in PCT/US05/05803, filed Feb. 23, 2005, entitled “Multiple Electrospray Needle Interface for Mass Spectrometry,” the contents of which are incorporated by reference herein. A given probe may then be dedicated to either a (+) mode or (−) mode analysis.

The analytes being characterized in each extracted sample may be the same or may be unique to a given analysis. If IPMS system 100 were to spike for only one analyte during any given measurement cycle, the amount of time necessary to determine the concentrations of all the analytes of interest could become prohibitive. Thus, spike source 135 may contain a plurality of different spikes such that module 130 spikes the extracted sample simultaneously for a plurality of analytes. The spike solution added to the sample within module 130 may thus be a mixture of multiple spikes.

Given the plurality of spikes and analytes that may be present in the ionized mixture being analyzed by mass spectrometer 140 in IPMS system 100, a variety of mass spectrometer tunings may be used. For example, various settings such as capillary voltages, skimmer voltages, pulser voltages, and detector voltage levels comprise a mass spectrometer tuning. Each tuning is used to characterize a certain mass range. For example, one tuning may be used to characterize analytes of relatively low molecular weight whereas another tuning may be used to characterize analytes of higher molecular weight. The range of masses observable for a given tuning may be denoted as a mass window. The mass windows may be identified by an element within the window. For each sample being processed by mass spectrometer 140, a plurality of mass windows will typically be analyzed. As disclosed in U.S. Provisional Application No. 60/711,083, filed Aug. 23, 2005, the contents of which are hereby incorporated by reference, the one or more processors (not illustrated) in controller 120 that control IPMS system 100 may be configured with a “data analysis engine” (DAE). The DAE uses the identity of the process solution being sampled and the mass spectrometer tunings to identify peaks of interest in the resulting mass spectrums from mass spectrometer 120. The DAE performs a ratio measurement using the identified peaks to calculate the concentrations of the analytes.

Mass spectrometer 140 analyzes the processed diluted and spiked sample from module 150 to produce mass spectra having both an analyte response and a spike response. Because the volume and concentration of the spike(s) added to the sample within module 130 is known, the concentration of an analyte in the sample may be determined from the ratio of the analyte and spike responses after appropriate processing. The nature of the spike depends upon the analyte to which it corresponds. The spike may be an isotope dilution mass spectrometry (IDMS) spike such that it alters a naturally occurring isotopic ratio for the analyte. Alternatively, the spike may be a chemical homologue of analyte in an internal standard approach. Regardless of the nature of the spike, the resulting ratio measurement cancels out drift and other inaccuracies, thereby enabling automated operation over lengthy periods of time.

Advantageously, controller 120 controls the remaining components in IPMS system 100 such that continuous real time analysis of organic additives and their breakdown products may be performed on bath 110. Each extracted sample that is processed through IPMS system 100 may be considered to correspond to an analysis cycle. IPMS system 100 cycles through such analysis cycles without the need for any human intervention. In some embodiments, an extracted sample may be analyzed in one calculation cycle for the organic additives of interest and their breakdown products. However, because each organic additive may be better analyzed at a given state of under or over precipitation from matrix elimination module 150, the following discussion will assume that accelerator, suppressor, and leveler each has their own dedicated analysis cycle. In other words, in a first analysis cycle, IPMS system 100 extracts a sample and, for example, analyzes the concentration of accelerator and its related breakdown products. In a second analysis cycle, IPMS system may extract and analyze the concentration of, for example, suppressor, and so on.

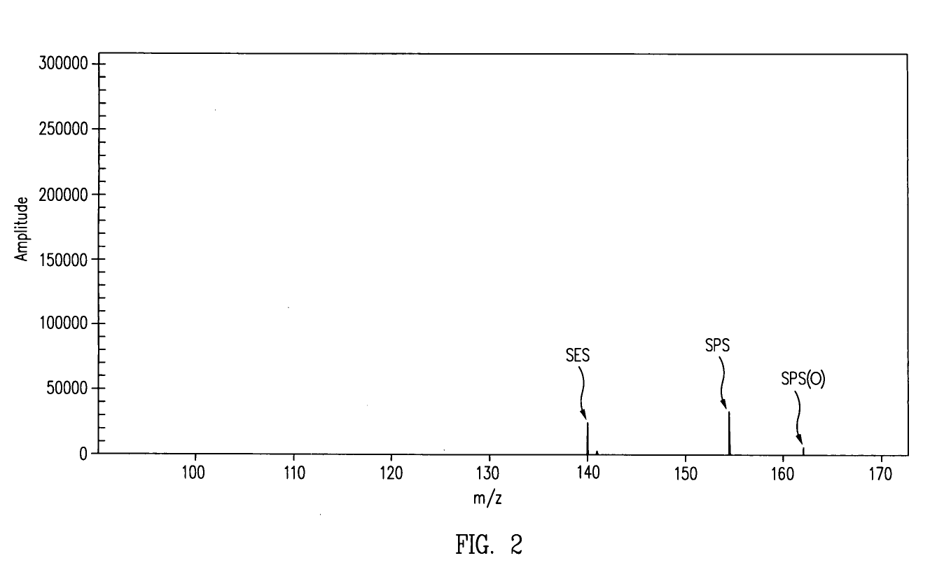

An analysis cycle for the accelerator bis (3-sulfopropyl) disulfide (SPS) will first be described. A suitable spike to determine the concentration of SPS is bis (3-sulfoethyl) disulfide (SES), which ionizes in solution as [O₃S(C₂H₄)SS(C₂H₄)SO₃]²⁻. During operation of bath 110, SPS breaks down to form a variety of breakdown products. For example, SPS breaks down to form SPS(O), which ionized in solution as [O₃S(C₃H₆)S═OS(C₃H₆)SO₃]²⁻. A suitable spike to determine the concentration of SPS(O) is SES. Thus, an extracted sample may be spiked with SES to characterize the concentrations of both SPS and SPS(O). A resulting spectrum is illustrated in FIG. 2.

Advantageously, IPMS system 100 may thus monitor the concentration of a variety of organic breakdown products from SPS as well as the concentration of SPS itself in single analysis cycle by spiking simultaneously with SES. In addition, other spikes may be used to characterize lighter-weight breakdown products. A similar analysis cycle may be performed to monitor the concentration of suppressor and suppressor breakdown products. One form of suppressor comprises a co-polymer of ethylene oxide and propylene oxide having a formula of (PEG)ₘ(PPG)ₙ, where PEG stands for polyethylene glycol and PPG stands for polypropylene glycol. One suitable spike for such a suppressor comprises a PEG with an average molecular weight of 500 and a methoxide Me terminal group. Because both the suppressor and spike are neutral organic compounds, the solution of Ba(OH)2 added to the diluted and spiked sample in module 150 may also include a source of Na ions such as NaCl. As known in the art, the Na ions associate with the neutral organic polymers during the electrospray process so that the polymers may be ionized. Because the polymers and their breakdown products with thus be positively charged, their IPMS analysis is preferably performed in the (+) mode. The PEG spike also reacts with the Na ions and appears in both a singly or doubly charged form in the mass spectrum depending upon whether a given molecule of PEG associates with one or two Na ions.

The (PEG)ₘ(PPG)ₙ polymer hydrolyzes into various smaller molecular weight (PEG)ₘ(PPG)ₙ polymers. Thus, in addition to spiking with a relatively-high molecular weight spike, another spike may be added having a lower molecular weight to characterize the breakdown products. In this fashion, breakdown products such as in the range of (PEG)₁₋₆(PPG)₀₋₄ may be analyzed.

Leveler may be analyzed analogously in the (+) mode in another analysis cycle. For example, if the leveler comprises a polyethyleneimine polymer, a suitable spike comprises an isotopically-labeled polyethyleneimine polymer. During use, a polyethyleneimine leveler may have moieties oxidatively cleaved. As a result, the organic breakdown products include these moieties and the remaining leveler “backbone.” To monitor concentrations of these breakdown products, a suitable spike may comprise an isotopically-labeled form of the breakdown product.

It will thus be appreciated that IPMS system 100 may be configured to monitor both the concentration of organic additives as well as their corresponding breakdown products in semiconductor plating solutions. Advantageously, this monitoring may be performed unattended and in real time. For the first time, a semiconductor manufacturer has a window into the chemistry of their plating solutions. For example, it is conventional to “dose” a semiconductor plating bath by occasional additions of the organic additives based upon suspected breakdown rates. In conjunction with IPMS monitoring, the dosing of these organic additives may be preformed based upon real time measurements of the corresponding concentrations rather than upon suspected or presumed breakdown rates. For example, the concentration of accelerator may be measured using the IPMS techniques described above and compared to an acceptable or desired concentration range. If the concentration of accelerator has dropped below the desired range, a corresponding amount of accelerator may be added to the bath to bring the concentration back into the desired range. Similar dosing operations may be performed for suppressor and leveler. In this fashion, IPMS measurements allow a user to maintain homeostasis in the plating bath

In addition to dosing, it is conventional to “bleed and feed” a plating bath by draining portions of the bath and replacing with fresh plating solution. In this manner, the breakdown product concentrations may be diluted to acceptable levels. However, just as discussed with regard to dosing schedules, the rate at which solution is replaced is based upon presumed or suspected breakdown product concentrations. By monitoring the breakdown product concentrations using IPMS as discussed above, a manufacturer may replace portions of the bath based upon known rather than suspected or believed organic breakdown product concentrations.

Using IPMS, the manufacturer may now monitor both the organic additives and their breakdown products and compare these concentrations with semiconductor yields. In this fashion, should a batch of plated wafers be faulty, the corresponding concentrations of the organic additives and their breakdown products may be analyzed to identify undesirable breakdown product concentrations and/or undesirable organic additive concentrations. In addition, desirable breakdown product concentrations and/or desirable organic additive concentrations may be accurately identified.

IPMS allows a manufacturer to monitor the bath to determine the optimum number of process conditioning wafers that must be processed to condition the bath. Process conditioning wafers are blank wafers that are processed like production material to bring the process to “stability” and re-qualify it for production after Cu ECD bath change. The stability comes about through generation of desired organic breakdown product concentrations. Conditioning wafers are very expensive and large numbers of them are sometimes used. By monitoring bath chemistry using IPMS, a manufacturer may use the optimum number of conditioning wafers that will bring the bath to “stability.” In this fashion, the number of conditioning wafers used to condition the bath may be minimized. Moreover, because IPMS measurements allow the identification of desirable organic breakdown product concentrations, these desirable organic breakdown products may be treated as organic additives in that they are then used to dose a plating bath. In this fashion, a user could provide a stable plating bath without ever needing to use conditioning wafers. In addition, the need to process test wafers is also minimized or eliminated. It is conventional to use test wafers to determine the quality of a plating bath by testing the grain size and other features of the resulting plated test wafer. However, through intelligent management of the bath through the techniques disclosed herein, the necessity to test bath quality through the use of test wafers may be minimized or eliminated.

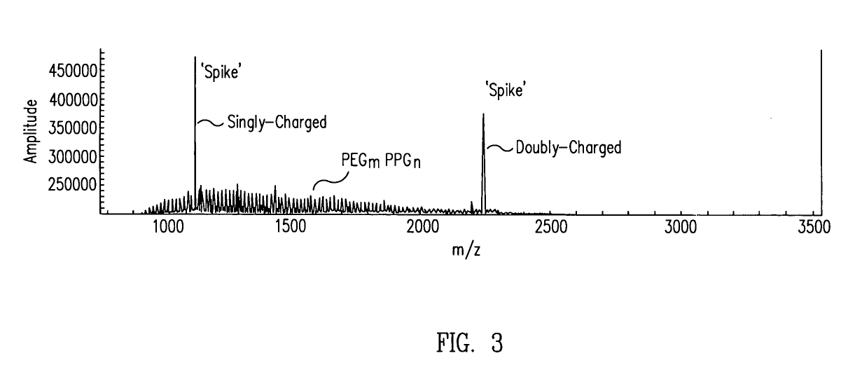

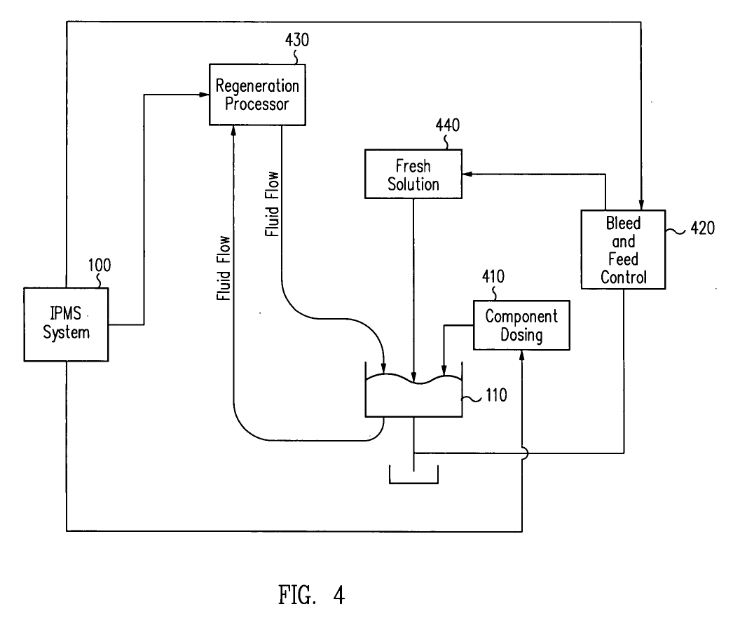

The management of plating baths using IPMS may be better understood with reference to FIG. 3. A sample is taken from bath 110 and analyzed by IPMS system 100. The concentrations of additives and their breakdown products are then compared with a known good composition and the bath is adjusted accordingly. IPMS system 100 is configured to control bath chemistry using one or more of the following methods: dosing 310, and bleed and feed control 320 wherein some of the solution is drained out and fresh solution 340 is added. In addition, IPMS system 100 may control a regeneration processor 330. Regeneration processor 330 functions to remove breakdown products or other undesirable species from bath 110 using, e.g., filters or ion-exchange chromatography. Because IPMS system 100 may measure the breakdown product concentrations, regeneration processor 330 may be controlled to function only as needed. It is also recognized that a fresh semiconductor metal plating bath in general does not include any breakdown products and that IPMS system 100 can be used to control the use of bath conditioning wafers until the bath composition, including breakdown products, falls within control limits. This control can either be predetermined by the IPMS system 100, i.e. determined by measurements of changes in bath composition on prior baths or dynamically determined by the IPMS system 100.

The described embodiments of the present invention are merely meant to be illustrative and not limiting. For example, the mass spectrometer need not utilize atmospheric pressure ionization such as electrospray but instead may utilize other ionization sources such as inductively-coupled plasma ionization. Other types of process solutions may have their chemistries managed using IPMS in addition to electroplating solutions. In addition, only those claims which use the phrase “means for” are intended to be interpreted under 35 USC § 112, 6th ¶. Moreover, no limitations from the specification are intended to be read into any claims unless those limitations are expressly included in the claims. Thus, the scope of the present invention is defined only by the following claims.

We claim:

1. A method of analyzing a semiconductor processing solution having at least one organic additive, comprising:
(a) spiking a sample of the semiconductor processing solution with a first spike corresponding to the at least one organic additive and a second spike corresponding to at least one organic breakdown product of the organic additive;
(b) processing the sample through a mass spectrometer to form an organic additive response, a first spike response, a breakdown response, and a second spike response; and
(c) in a processor, calculating a concentration of the at least one organic additive using a ratio measurement derived from the organic additive response and the first spike response and calculating a concentration of the at least one organic breakdown product using a ratio measurement derived from the breakdown response and the second spike response.

2. The method of claim 1, further comprising:
repeating acts (a) through (c) a first number of cycles during the processing of semiconductor wafers using the semiconductor processing solution such that a given cycle of acts (a) through (c) correspond to a given processed semiconductor wafer, thereby producing a first set of concentrations for the at least one breakdown product, each concentration in the first set corresponding to a given cycle;
classifying the wafers based upon their quality; and
responsive to the quality classifications, determining an acceptable concentration range for the at least one breakdown product.

3. The method of claim 2 further comprising:
repeating an additional cycle of acts (a) through (c) to determine a concentration of the at least one organic breakdown product corresponding to the additional cycle; and
if the concentration of the at least one organic breakdown product corresponding to the additional cycle is not within the acceptable concentration range; performing an act to bring the concentration into the acceptable range, the performed act being selected from the group consisting of adding an amount of the at least one organic breakdown product to the semiconductor processing solution and removing a portion of the semiconductor processing solution and replacing the removed portion with fresh semiconductor processing solution.

4. The method of claim 2, wherein the semiconductor wafers are conditioning wafers, the method further comprising determining an optimum number of conditioning wafers.

5. The method of claim 2, wherein the semiconductor wafers are test wafers, the method further comprising determining an optimum type and number of test wafers.

6. The method of claim 1, further comprising:
repeating acts (a) through (c) a first number of cycles during the processing of semiconductor wafers using the semiconductor processing solution such that a given cycle of acts (a) through (c) correspond to a given processed semiconductor wafer, thereby producing a first set of concentrations for the at least one organic additive, each concentration in the first set corresponding to a given cycle;
classifying the wafers based upon their quality; and
responsive to the quality classifications, determining an acceptable concentration range for the at least one organic additive.

7. The method of claim 6, wherein the at least one organic additive comprises an additive selected from the group consisting of accelerator, suppressor, and leveler, the method further comprising:
repeating an additional cycle of acts (a) through (c) to determine a concentration of the at least one organic additive corresponding to the additional cycle; and
if the concentration of the at least one organic additive corresponding to the additional cycle is not within the acceptable concentration range; performing an act to bring the concentration into the acceptable range, the performed act being selected from the group consisting of adding an amount of the at least one organic additive to the semiconductor processing solution and removing a portion of the semiconductor processing solution and replacing the removed portion with fresh semiconductor processing solution.

8. The method of claim 7, wherein the at least one organic additive comprises SPS.

9. An IPMS system for managing a semiconductor processing solution, comprising:
a sample extraction module operable to extract samples from the semiconductor processing solution;
a sample dilution and extraction module operable to spike and dilute the extracted samples to form first processed samples;
a matrix elimination module operable to remove an interfering matrix from the processed samples to form second processed samples;
an ionization source operable to ionize the second processed samples to form ionized samples;
a mass spectrometer operable to analyze the ionized samples to form mass spectrums having spike and analyte responses; and
at least one processor operable to measure concentrations of at least one organic additive and at least one corresponding organic breakdown product in the extracted samples using ratios derived from the analyte and spike responses.

10. The IPMS system of claim 9, wherein the at least one processor is further operable to compare the measured concentrations of the at least one organic additive to desired concentrations ranges.

11. The IPMS system of claim 10, wherein the at least one processor is further operable to command for the addition of the at least one organic additive to the semiconductor processing solution if the measured concentrations are outside the desired concentration ranges.

12. The IPMS system of claim 11, wherein the at least one organic additive comprises suppressor.

13. The IPMS system of claim 11, wherein the at least one organic additive comprises accelerator.

14. The IPMS system of claim 11, wherein the at least one organic additive comprises leveler.

15. The IPMS system of claim 13, wherein the accelerator comprises SPS.

16. The IPMS system of claim 11, further comprising:
a regeneration processor operable to remove the organic breakdown product from the semiconductor process solution, wherein the at least one processor controls the removal of the organic breakdown product by the regeneration processor responsive to the measured concentration of the organic breakdown product.

17. A method of analyzing a semiconductor processing solution having at least one organic additive, comprising:
(a) spiking a sample of the semiconductor processing solution with a first spike corresponding to the at least one organic additive and a second spike corresponding to at least one organic breakdown product of the organic additive;
(b) processing the sample through an analytical instrument to form an organic additive response, a first spike response, a breakdown response, and a second spike response; and
(c) in a processor, calculating a concentration of the at least one organic additive using a ratio measurement derived from the organic additive response and the first spike response and calculating a concentration of the at least one organic breakdown product using a ratio measurement derived from the breakdown response and the second spike response.

18. The method of claim 17, wherein the semiconductor processing solution comprises a Cu plating bath solution, the method further comprising:
repeating acts (a) through (c) to determine a desirable concentration range for the at least one organic additive and for the corresponding at least one organic breakdown product; and
forming a fresh Cu plating bath solution according to the determined desired concentration ranges.

19. The method of claim 17, wherein the analytical instrument comprises a liquid chromatograph, the method further comprising: repeating acts (a) through (c) during the processing of semiconductor wafers using the semiconductor processing solution;
comparing the concentration of the at least one organic breakdown product to a desired concentration; and
if the concentration of the at least one breakdown product is unacceptable,
removing a portion of the semiconductor processing solution and replacing the removed portion with fresh semiconductor processing solution.

20. The method of claim 17, wherein the analytical instrument is a mass spectrometer.
